(19) United States
(12) Patent Application Publication
(10) Pub. No.: US 2008/0137533 A1
(43) Pub. Date: Jun. 12, 2008

(54) Method and System for Reconstructing Bandwidth Requirements of Traffic Stream Before Shaping While Passively Observing Shaped Traffic

(75) Inventors: Raymond Russell, Dublin (IE); Dmitri Botvich, Dublin (IE); Donal O'Sullivan, Dublin (IE); Matthew Charles Davey, Dublin (IE)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: CORVIL LIMITED, Dublin (IE)

(21) Appl. No.: 11/722,699

(22) PCT Filed: Dec. 23, 2004
(86) PCT No.: PCT/IE2004/000175

§ 371 Date: Aug. 1, 2007

(30) Foreign Application Priority Data
Dec. 23, 2004 (WO) PCTIE2004000175

(51) Int. Cl. H04L 12/56

(52) U.S. Cl. 370/230.1

(57) ABSTRACT

Embodiments of the present invention may relate to methods of traffic measurement on a network. In some embodiments, the methods may include obtaining a measure of shaped traffic before shaping on the basis of passive traffic observations of the shaped traffic. In one embodiment, the method may include analysing a traffic aggregate of packets in a network comprising: separating the traffic aggregate into a series of individual co-temporal sub-aggregates; and performing a measurement using the individual sub-aggregates of the series to obtain a statistical measure for the traffic aggregate.

### FIELD OF THE INVENTION

The present invention relates to communication networks and specifically to packet based data communication networks. In particular, the invention relates to a method for quality of service measurement of traffic aggregates before shaping on the basis of passive traffic observations obtained post shaping.

### BACKGROUND OF THE INVENTION

The present invention applies to communications networks, including IP (internet protocol) networks, ATM networks and other packet switched communications networks. A communication network is a collection of network elements interconnected so as to support the transfer of information from a user at one network node to a user at another. The principal network elements are links and switches. A link transfers a stream of bits from one end to another at a specified rate with a given bit error rate and a fixed propagation time. In this specification we refer to the rate at which a buffer is served as the service capacity, measured in bits per second. Other common terms for service capacity are link-rate and bandwidth. The most important links are:

optical fibre;

copper coaxial cable;

microwave wireless.

Several incoming and outgoing links meet at a switch, a device that transfers bits from its incoming links to its outgoing links. The name “switch” is used in telephony, while in computer communications, the device that performs routing is called a router; the terms are used interchangeably in this specification. When the rate of incoming bits exceeds that of outgoing bits, the excess bits are queued in a buffer at the switch. The receiver of each incoming link writes a packet of bits into its input buffer; the transmitter of each outgoing link reads from its output buffer. The switch transports packets from an input buffer to the appropriate output buffer. An schematic example of such a network arrangement is shown in FIG. 1 where a router 100 including an input buffer 110 and an output buffer 120 is used to couple one or more incoming links 130 with one or more outgoing links 140.

The quality of a communications network service, as perceived by a user, varies greatly with the state of the network. To make packet-switched networks economically viable, it is necessary to be able to guarantee quality while reducing capital investment and operating expenses.

Degradation in the perceived quality of a service can often be traced back to loss or delay of data packets at a node or switch in the network. User satisfaction can be guaranteed by managing loss and delay of packets at those nodes where congestion can occur.

Typically, users transmit bits in bursts: active periods are interspersed with periods of inactivity. The peak rate of transmission cannot exceed the link rate. The mean rate of transmission, by definition, cannot exceed the peak rate.

Loss and delay of data packets at a node in the network arise from the queuing of packets in the buffers of switches or routers. Buffers are required to cope with fluctuations in the bit-rate on incoming links. However, if the buffers are too small, packets will be lost as a result of buffer overflow; if the buffers are too large, some packets will experience unacceptable delays. For a given buffer-size, loss and delay can be reduced by increasing the capacity of the outgoing link.

To eliminate packet loss entirely, it would be necessary to increase the capacity of the outgoing link to equal the sum of the capacities of the incoming links. This is prohibitively expensive. Nevertheless, it is a strategy employed sometimes by network operators who take a conservative view on assuring network quality of service.

Another known technique is based on an understanding that it is unnecessary to eliminate packet loss and unacceptable packet delay in order to give satisfactory perceived quality. It is enough to keep their frequency within predetermined bounds. These bounds are referred to as Quality of Service (QoS) targets.

The optimal way to ensure satisfactory perceived quality is to provide the minimum capacity that will guarantee the QoS targets. This minimum capacity is referred to as the Bandwidth Requirement (BWR) of the bit-stream. It lies somewhere between the mean rate and the peak-rate requirement.

Various techniques are known for the measurement and estimation of BWR that will guarantee QoS targets. However, a problem that arises in these measurements is that the traffic in all likelihood has been shaped before arriving at the point of measurement. In networks, traffic aggregates experience so-called “shaping effects” whilst traversing through networks. A traffic aggregate is any grouping of network traffic. An aggregate is usually defined using a packet filter. A traffic aggregate may be defined by a variety of different parameters including the source, destination and type of traffic. The traffic aggregate may be real in the sense that it could define all traffic arriving through a particular router. Alternatively, a traffic aggregate could be artificial in the sense, for example, that it could comprise traffic being analysed for a possible reconfiguration on the network rather than a current implementation. Thus, for example, a traffic aggregate may be defined to investigate the possibility of changing router configuration or to investigate the possibility of installing a new router to handle some traffic from one or more existing routers.

The shaping of the aggregates is caused by, inter-alia, queuing, packet delay and jitter at routers, arising from a number of different reasons. One reason in particular is the use of packet buffering and the different time is required by a router to process different packets. Additionally router/switch internal procedures influence delays and jitter also. It is important to emphasize that by shaping, is meant practically everything that influences packet jitter and packet losses.

Traffic measurement typically involves using counters to record values such as, for example, the number of data packets and the volume of data moving along a link. These counters are periodically inspected and the values used in the measurement of statistical characteristics regarding the performance of the network. It will be appreciated that a variety of different statistical measurement techniques are available. Nonetheless, because of shaping effects the statistical characteristics of traffic aggregates are significantly changed when traffic aggregates traverse through network. These statistical characteristics include the statistical Quality of Service (QoS) parameters such as the Essential Bandwidth with loss and/or delay targets. Specific statistical descriptors for the assignee/applicant of the present invention include CORVIL™ traffic descriptors (CTD's) and CORVIL™ essential bandwidth. The so-called essential bandwidth is also sensitive to shaping as the peak rate used in its calculation is very sensitive to traffic shaping. A description of the concept of essential bandwidth is contained in F. P. Kelly, S. Zachary and I. Zeidens, editors, Stochastic Networks: Theory and Applications, Royal Statistical Society Lecture Notes Series, Chapter 8, pp. 141-168, Oxford University Press, 1996, the entire contents of which are hereby incorporated by reference. It will be appreciated that a variety of different traffic descriptors and bandwidth measurement tools are employed by different suppliers and the present invention should not be construed as being limited to any particular method of calculation or implementation. As result of shaping the QoS related statistical characteristics of the same traffic aggregate are different before and after shaping, or more generally at different measurement points (i.e. the location of probes at different routers/switches).

Some examples of when it is desirable to get such measurements are set out below. These examples whilst of important application for the method of the invention are not exhaustive of the situations of application of the present invention but merely exemplary. In the first example, hereinafter referred to a 1-layer probe where we are interested in reliable measurements of traffic before it is shaped by the router attached to the probe as illustrated in FIG. 2. In the second example, hereinafter referred to as a 2-layer probe scenario, we are interested in reliable measurements of traffic not only before it is shaped by the router attached to the probe but also before routers of previous layer as illustrated in FIG. 3.

In FIG. 2, the probe is located after router R1. We are interested in the essential bandwidth measurements before router R1, i.e. on links (R2, R1), (R3, R1), (R4, R1). This is 1-layer scenario: we are interested in measurements just before router attached to the probe.

The major challenge with measurements of traffic or bandwidth requirements\usage in the mentioned scenario is that when a traffic aggregate goes through a router it is shaped, and, as consequence of this, its statistical properties are changed. So that above described use of counters is unsuitable to provide a statistical measure of the traffic before shaping. As result of this the traffic descriptors (e.g. CTD's) and/or bandwidth estimates (e.g. CORVIL™ essential bandwidth) “before router” are different from measurements made “after router”. The difference is typically larger for higher loads.

The consequences of this will now be explained, with reference to FIG. 3, in which the probe is located after a router R1. We are interested in traffic measurements before router R1, in particular, on links (R2, R1), (R3, R1), (R4, R1), but also before routers R2, R3, R4. This is a 2-layer scenario: we are interested in measurements not only before router attached to the probe, but also before the next layer routers.

The challenges with measurements of traffic and bandwidths in this scenario is that when a traffic aggregate goes through two routers it is shaped by both routers, and, as consequence of this, its statistical properties are changed even more than in the previous scenario. As result of this the traffic measurements and bandwidth measurements before routers” R2, R3, R4 can be quite different from the values measured “after router” R1. The difference is typically larger with higher loads at any of routers on the traffic aggregate path.

Although, the problem could be solved by increasing the number of locations with probes, i.e. such that there was a probe at each point of interest, there are both economic and technical reasons why this may not be possible or practical. For example, the cost of deploying probes in order to make QoS measurements may be uneconomic or certain areas of the network may be inaccessible to the company seeking to deploy the probes.

### SUMMARY OF THE INVENTION

The inventors of the present invention have solved these problems by realising that traffic sub-aggregates for a traffic aggregate will be less shaped than the traffic aggregate itself. Thus by separating a traffic aggregate to be analysed into a series of sub-aggregates and using these sub-aggregates to obtain a measure of the traffic aggregate, the result will be a closer reflection to the true picture of the traffic prior to shaping.

Accordingly, a first embodiment of the invention provides a method of analysing a traffic aggregate of packets in a network comprising the steps of: separating the traffic aggregate into a series of individual co-temporal sub-aggregates; and performing a measurement using the individual sub-aggregates of the series to obtain a statistical measure for the traffic aggregate. The method may comprise the initial step of identifying the traffic aggregate. This identification may be performed using a packet filter. The method of separating the traffic aggregate is suitably selected so as to provide statistical independence vis a vis the sub-aggregates. One method which provides statistical independence is the separating step is the use of a hash function to determine the appropriate sub-aggregate for a packet. Suitably, the hash function has x possible results where x is the number of sub-aggregates. One possible hash function uses modulo division performed on the weighted sum of a plurality of fields from the packet header for of individual packets. The plurality of fields may include one or more of the following: Source IP address, Source port number, destination IP address, destination port number and the TOS field. A specific hash function may be defined as H(packet)=[a₁*source_IP_address+a₂*source_port_number+a₃*destination_IP_address+a₄*destination_port_number+a₅*TOS_field] (modulo M), where a₁, a₂, a₃, a₄ and a₅ are suitably selected constants and M is the number of sub aggregates. The step of performing a measurement may comprises the steps of: calculating individual cumulant generating functions for each sub-aggregate, and summing the calculated individual cumulant generating functions to provide a combined cumulant generating function. This combined function provides a statistical measure for the traffic aggregate. The step of performing a measurement using the individual sub-aggregates may comprise the step of time-shift multiplexing the sub-aggregates together to produce a reconstructed traffic aggregate, and performing a calculation on the reconstructed traffic aggregate to produce a traffic estimate. Suitably, in this time-shift multiplexing, each sub-aggregate is time-shifted by a different amount. The method may additionally comprise the step of estimating a traffic congestion state on the network to provide an indicator for the reliability of the traffic estimate. This traffic congestion state may be calculated by determining a load level for the traffic. The congestion state estimation also applies where there are a number of intervening points between the location of the point of measurement for the traffic aggregate and the actual traffic aggregate itself, in this case the traffic congestion state is determined at each of said intervening points.

A second embodiment of the invention provides a system for analysing traffic in a network comprising: a traffic aggregator for identifying a traffic aggregate of interest, a sub-aggregator for separating the traffic aggregate into a series of individual sub-aggregates, where each sub-aggregate and the aggregate are co-temporal, and a traffic measurement module for performing a measurement using the individual sub-aggregates of the series to obtain a statistical measure for the traffic aggregate. Suitably, the traffic aggregator comprises a packet filter. The sub-aggregator may be adapted to separate the traffic aggregate with substantially statistical independence between sub-aggregates. The Separation may be through the use of a hash function for each packet in the aggregate. In which case, the hash function suitably has x possible results where x is the number of sub-aggregates. The hash function may comprise the implementation of a modulo division performed on the weighted sum of a plurality of fields from the packet headers of individual packets. Suitably, the plurality of fields include one or more of the following: source IP address, source port number, destination IP address, destination port number and the TOS field. A specific case for the implemented hash function may be defined as H(packet)=[a₁*source_IP_address+a₂* source_port_number+a₃*destination_IP_address+a₄*destination_port_number+a₅*TOS_field] (modulo M), where a₁, a₂, a₃, a₄ and a₅ are suitably selected constants and M is the number of sub aggregates. The traffic measurement module may be adapted to perform the steps of: calculating individual cumulant generating functions, and

summing the calculated individual cumulant generating functions to provide a combined cumulant generating function which may function as a statistical measure for the traffic aggregate. Suitably, the traffic measurement module is adapted to calculate the individual cumulant generating functions using many sources asymptotics. In one case, the traffic measurement module may be adapted to time-shift multiplex the sub-aggregates together to produce a reconstructed traffic aggregate and further adapted to calculate a traffic estimate from the reconstructed traffic aggregate. Suitably, the traffic measurement module is adapted to apply a different time shift to each sub-aggregate. In one addition, a congestion state module may be included to provide an indicator of the traffic congestion on the network. The traffic congestion module may be adapted to determine said indicator by determining a load level for the traffic. In situations where there are a number of intervening points between the location of the point of measurement for the traffic aggregate and the actual traffic aggregate itself, the traffic congestion module may be adapted to determine said indicator by determining the traffic congestion state at each of said intervening points.

### BRIEF DESCRIPTION OF THE DRAWINGS

The present invention will now be described with reference to the accompanying drawings in which:

FIG. 1 is a typical example of a router in a packet based network,

FIG. 2 is an exemplary first scenario where the present invention may be employed,

FIG. 3 is an exemplary second scenario where the present invention may be employed,

FIG. 4 is a further exemplary scenario where the present invention may be employed,

FIG. 5 is a system according to an embodiment of the present invention,

FIG. 6 is a method according to an embodiment of the present invention,

FIG. 7 is a method according to another embodiment of the present invention, and

FIG. 8 is a method according to a further embodiment of the present invention.

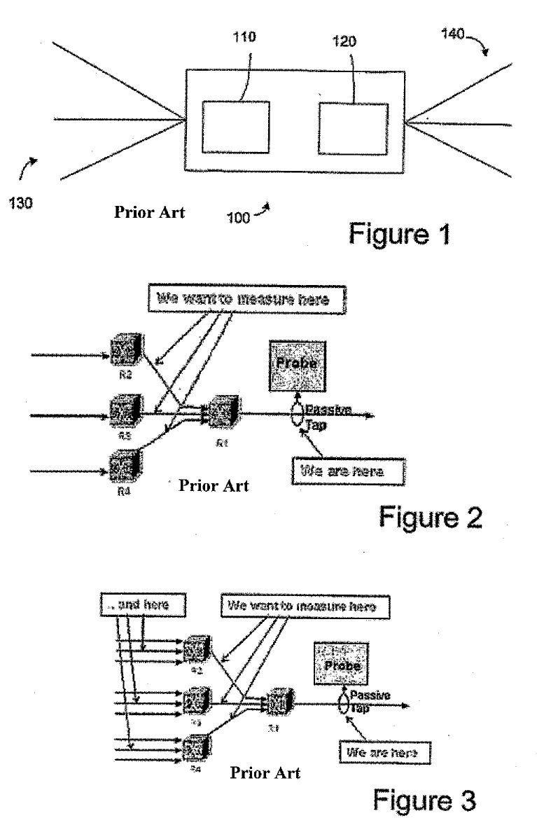

### DETAILED DESCRIPTION OF THE DRAWINGS

The present invention may be implemented in a number of different schemes including as part of a router\switch, for simplicity however the present invention will be described with reference to implementation as a passive probe tapped to a link of interest in a communications network. The probe itself may be of any conventional design, since the invention lies in the method of analysis and not the method of acquisition. For example, in one arrangement the probe may be used to extract information from packets passing over the link, with the identification of the traffic aggregate and subsequent steps of the method being performed elsewhere on the basis of the information extracted by the probe.

An exemplary traffic analysis system according to the invention is shown in FIG. 5. The system 500 is shown as comprising a number of distinct modules. However, it will be appreciated that this is merely for the purposes of explaining the system. In practise, the elements and functionality of the system may be implemented within one or more systems in either software or hardware or a combination thereof. The system comprises a probe 504 which is adapted to examine individual packets as they pass along a network path (link) 502. The probe may be a standalone probe or, for example, integrated within the functionality of another network device, e.g. a router. The probe suitably comprises a traffic aggregator adapted to identify and extract a traffic aggregate of interest. There are a variety of different methods for identifying a traffic aggregate, the most common of which is a packet filter 506. The packet filter inspects the headers of packets and applies a filter function to identify an aggregate of interest. The aggregate of interest is defined by the packet filter parameters. In the context of the present invention, the contents per se of the packets is not of significant interest. Instead, the size and quantity of packets is generally of more interest as these parameters are used to perform a measurement of the traffic. Thus the packet filter may be adapted to supply information on the packets rather than the packets themselves to subsequent parts of the system.

The packets (or as explained information regarding the packets) for the aggregate of interest are passed to a sub-aggregator 510, the function and operation of which will now be explained. A key idea behind the present invention is related to the observation of the present inventors that if an aggregate is split into a number of individual sub-aggregates then individual sub-aggregates are likely to be less shaped than the aggregate. Accordingly, the inventors have applied this so that the traffic aggregate passed from the traffic aggregator to the sub-aggregator 510 is separates into a series of sub-aggregates. Some exemplary methods of operation of the traffic aggregator are explained below. A sub-aggregate of a traffic aggregate consists of a portion of packets from the aggregate. The number of sub-aggregates should be large enough for statistical purposes (ranges discussed below). It is also preferable that the individual sub-aggregates are sufficiently active and in particular it would be undesirable to have one sub-aggregate that dominates, for example in that sense it takes more than 50% of aggregate load. In this context it will be appreciated that the individual sub-aggregates and the aggregate are co-temporal. By co-temporal is meant that the period of measurements for the individual sub-aggregates and the aggregate are the same. Thus, for example, if the period of measurement for an aggregate is five minutes, the period of measurement for each of the individual sub-aggregates is also effectively the same five minutes.

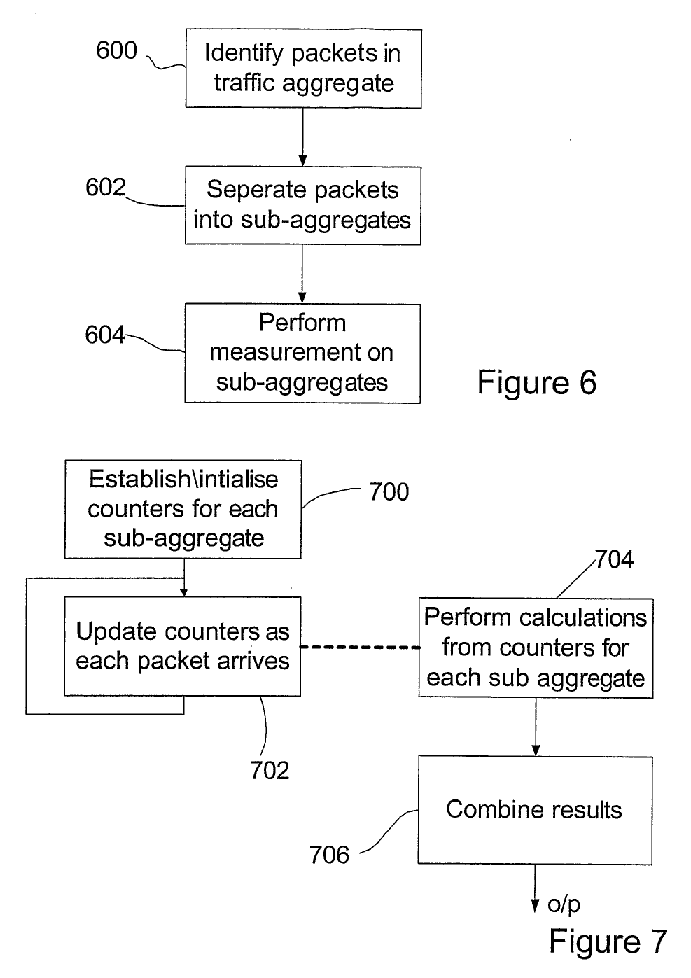

The method of the invention will now be described in greater detail with reference to FIG. 6. The method commences with the probe identifying an aggregate of interest (Step 600). As described above, this may be by means of a packet filter.

Once an aggregate of interest has been determined, traffic of the aggregate is examined and separated into sub-aggregates (step 602) by the sub-aggregator 510. The sub-aggregator preferably employs an efficient method for sub-aggregation. It is advantageous, if the sub-aggregator only requires information which readily available to the probe, namely, the information contained in the packet headers. Suitably, the method of separating the traffic aggregate is selected so as to substantially provide statistical independence vis a vis the sub-aggregates. It will be appreciated that the term substantially is used as there may be some limited statistical independence between sub-aggregates which for most purposes may be ignored. Similarly, care should be taken in selecting the method of separating the traffic aggregate to ensure it is performed on a flow level, i.e. that each individual flow should belong to only one sub-aggregate. Thus two packets of the same flow should not belong to different sub-aggregates of the same aggregate. The motivation behind this is to ensure that sub-aggregates are relatively independent in the statistical sense. The independence assumption is employed later in the method of the invention. Thus, simpler methods of splitting packets of the aggregates into sub-aggregates, for example in a “round-robin” or random fashion would not work in the present invention method due to the strong dependency between different sub-aggregates.

An exemplary method of assigning flows to sub-aggregates will now be explained which comprises the following stages; Firstly, the number of sub-aggregates (M) is determined, typically this would be a predefined figure. A suitable range for selection of M from is between 5 and 30, with the preferable range being between 10 and 20. Once the number of sub-aggregates is assigned, the individual sub-aggregates are indexed, e.g. from 0 to M−1.

A function (H), which we will refer to as a hash function, provides an integer value from 0 to M−1 for a packet, which in turn allows an individual packet to be assigned to a sub-aggregate having the index of that integer. The hash function may be implemented within the sub-aggregator. The concept of a hash function will be readily understood by those in the art as it is commonly applied in the field, e.g. as a check digit for data transmission. In one exemplary embodiment, the hash function comprises a modulo division performed on the weighted sum of a plurality of fields from the packet header for an item function. The plurality of fields may include one or more of the following: Source IP address, Source port number, destination IP address, destination port number and the TOS (Type of Service) field.

One possible, but not unique way, to define the hash function is as follows:

### H(packet)=[a1*source_IP_address+a2*source_port_number+a3*destination_IP_address+a4*destination_port_number+a5*TOS_field] (modulo M),

where integer numbers a1, a2, a3, a4, a5 are chosen appropriately and fixed. One possible way to choose a1-a5 is to use sufficiently large different prime numbers, for example greater than 1000000.

Once a hash value has been calculated for a packet, the packet is assigned to the corresponding sub-aggregate having that index, i.e. a packet is assigned to the i-th sub-aggregate, where i=H(packet).

It will be appreciated that packets from a flow will be always assigned to the same sub-aggregate as source_IP_address, source_port_number, destination_IP_address, destination_port_number, TOS_field are identical for packets of same TCP or UDP flows. It will also be appreciated that individual packets are each assigned to only one sub-aggregate.

Once the packets have been assigned to a sub-aggregate, the sub-aggregates are directed to a traffic measurement module. The traffic measurement module may employ a number of different methods to perform a measurement (Step 604) on the individual sub-aggregates of the series to obtain a statistical measure for the traffic aggregate.

A first one of these methods uses a many sources asymptotics [or simply MSA] method described in the following documents; D. Botvich and N. Duffield. Large deviations, the shape of the loss curve, and economies of scale in large multiplexers. Queueing Systems, 20: 293-320, 1995, A. Simonian and J. Guibert. Large deviations approximation for fluid queues fed by a large number of on/off sources IEEE Journal of Selected Areas in Communications, 13: 1017-1027, 1995, and C. Courcoubetis and R. Weber. Buffer overflow asymptotics for a buffer handling many traffic sources. Journal of Applied Probability, 33: 886-903, 1996 the entire contents of which are incorporated herein by reference). The many sources asymptotic method is based on the large deviation theory and designed for the evaluation of queuing systems. In particular, the method of the present invention uses estimations for the finite time cumulant generating functions (which we will call here as MSA CGF) for each sub-aggregate involved.

An efficient method of applying a particular traffic measurement algorithm, including MSA CGF is to employ a series of counters, which will now be explained with reference to FIG. 7. The traffic measurement module suitably comprises a number of counters for each sub-aggregate. At the start of the process, these counters are created (if in software) and initialised (step 700). Suitably, the traffic measurement module employs two counters for each sub-aggregate: a first counter for recording the number of packets in a particular sub-aggregate and the second counter for recording the volume of data in the packets of the sub-aggregate. In operation, as packets arrive and are assigned to a sub-aggregate, the traffic measurement module updates the counters (step 702) for relevant sub-aggregate.

The method of updating counters may be described generally as follows:

### 1. Initialise all sub-aggregates counters (step 700) for all aggregates by 0, including packet counter and volume counter.

### 2. As each new packet arrives at the probe, determine to which sub-aggregates it belongs;

3. For each aggregate (in the case that more than one aggregate is being examined) to which the packet belongs update the appropriate sub-aggregate counters, i.e. increase the packet counter value by 1 and the volume counter by the volume of the packet (step 702).

### 4. Return to step 2 until the monitoring period is over.

In certain circumstances, it may also be useful to store additional information, including for example the arrival time of the last packet, as this additional information may be useful for performance optimisation purposes in some traffic measurement schemes.

Periodically, the counters for each sub-aggregate are inspected (Step 704). From the values obtained, statistical measures may be calculated for each sub-aggregate. It will be appreciated, the step of updating the counters continues during the period of measurement, whereas the inspection of the counters and calculation of statistical measures occurs on a periodic basis, for example, every 5 mSec. The results for the individual sub-aggregates may be combined (step 706) to produce an indication for the traffic prior to shaping.

Although, the above method provides a measure of the traffic before shaping in certain circumstances the results may be unreliable. In particular, the accuracy of the estimations produced by the method of the invention depends on many factors, including traffic load conditions, network topology, schedulers used and QoS targets. For example, there are traffic load conditions when the invention method does not produce reliable (i.e. accurate) estimations of the essential bandwidth. For example, in multi-layer situations where we are interested not only in QoS measurements on links directly attached to the router to which to the probe is attached but also on links not directly attached to the router (an example of such situation is depicted in FIG. 3). If we are interested in measuring the essential bandwidth before router R2, the traffic will be shaped at routers R1 and R2. Whilst in this case, the method for calculating the essential bandwidth measurement is substantially identical to a 1-layer scenario, the reliability of the results will be different.

Accordingly, a further aspect to the invention is the determination of the reliability of an estimate obtained by the systems and methods described herein. In this regard, an optional congestion state module may be employed within the system of the invention to provide an indication as to the reliability of traffic measurements. The congestion state module suitably accepts as an input information from the traffic measurement module regarding the volume of data being transmitted over a particular link or links and, depending on the type of queuing schedulers involved, the essential bandwidth measurements. The congestion state module may also require information to be entered by a user. This information may, for example, include the types of routers and the queuing techniques employed on particular links. Alternatively, it will be appreciated by those skilled in the art, that this information may be obtainable automatically. For example, if a router has a feature allowing for its interrogation by an external system. The exact method employed by the congestion state module will now be explained in greater detail.

Due to the number of factors (traffic load, topology, schedulers, QoS target values) influencing reliability of the methods of the present invention, it may appear at first too complicated and impractical to provide a reliability calculation method. However, the inventors of the present invention have determined that this is not necessarily the case. Moreover, the inventors have developed some rules which may be implemented relatively efficiently to check whether particular measurements are reliable or not. The rules are described in terms of some inequalities, involving readily obtainable parameters. These are either parameters that can be easily estimated at the traffic observation point (i.e. after shaping) by the probe or simple network configuration parameters such as link rates, types of schedulers, weights for the weighted fair queue (WFQ), etc. It should be appreciated that when the term reliability is used herein, it refers to the likelihood that a measurement provided from the method reflects the actual values (if they could have been measured directly).

In order to validate the rules developed, the inventors carried out extensive experiments to verify when the methods of the present invention were reliable and when not. At this point, it is also worth emphasizing that the experiments have shown that the above described methods produced reliable measurements for practically all realistic network settings and configurations.

To illustrate this point, a simple but important case: a 1-layer FIFO scenario as illustrated in FIG. 2 will be discussed. In this exemplary scenario, three regions of operation are identified. In the first region, the method may be (by experiment) taken as reliable (i.e. the estimation error is less than 5-10%) if:

load at router R₁<80% (1)

It should be noted that in this context, the load is measured as the ratio of the mean rate to link rate and multiplied by 100%. As an aside, it will be appreciated that in a well designed network the load would never normally exceed 50%.

Moreover, the measurements in this scenario are not reliable (e.g. errors are often more than 20-50% or even more) if the router is in a second region where:

load at router R₁ is >90%. (2)

The boundary case is the third region, when:

80%<load at router R₁<90% (3)

may also be usefully treated as being unreliable, although the estimation error is typically within 20%.

Accordingly, the first region (case 1) where the essential bandwidth estimations are reliable may be referred to as sub-critical, when it is unreliable (case 2) as the super-critical region and intermediate (case 3) as the critical region. Thus referring to the process of the determination when the essential bandwidth estimations are reliable as the congestion state evaluation and describing the corresponding congestion states as sub-critical, super-critical and critical, respectively. It will be appreciated that there is no precise boundary for deciding between what is sub-critical, super-critical and critical as the selection of a boundary between these regions is a somewhat subjective rather than an objective test.

In the case of more complex schedulers (e.g. priority scheduler and weighted fair scheduler (WFQ), similar (albeit more complex) rules on reliability may also be applied (described below).

The evaluation of the traffic aggregate congestion state is a significant part of the present invention as it allows the methods to be applied with some certainty as to the reliability of the results.

It will be appreciated that the traffic aggregate congestion state is associated with a particular traffic aggregate. Each traffic aggregate is defined at certain point in the network, whereas (in the case of a single probe) all traffic aggregates are observed at the same point where the probe is located. It will be appreciated that the congestion state is a dynamic object, which changes constantly over time. To account for this, the congestion state is evaluated periodically, for example, every 1 to 5 minutes.

We will denote the total traffic of the class i at a node as Pᵢ or the i-th primary aggregate. In the present context, a primary aggregate is a traffic aggregate which represents the total traffic of a particular traffic class at some node. The same procedure may be applied to the primary aggregate as is applied as to any traffic aggregate of interest.

As described above, the method of the present invention is reliable for a broad range of different network load conditions. The inventors of the present invention have defined critical parameters that are important means to determine the congestion state and have accounted for the fact that the critical parameters may be different for different types of schedulers. Using these critical parameters, the inventors have derived algorithms to determine the traffic aggregate congestion state, i.e. is it sub-critical, critical or super-critical.

It will be appreciated that a variety of different schedulers may be applied within any given router. The information regarding the configuration of routers on a network is however generally known to the person responsible for the network and thus may be entered manually into the congestion state module. Alternatively, some of this information may be available via interaction with the individual routers. The output from the congestion state module may be passed directly to a user identifying whether the results coming from the system are reliable. Alternatively, the output may be passed as an indicator of reliability to the traffic measurement system, which may be adapted to take the reliability indicator into account when presenting results to a user.

Different schedulers (e.g. FIFO, Priority Queue, WFQ) are characterized by different sets of critical parameter(s), which allows a determination as to whether the congestion state is sub-critical, where the method produces reliable estimations.

Some exemplary critical parameters will now be discussed. In the case of a FIFO queue, mean rate load may be viewed as the critical parameter and accordingly the essential bandwidth load may be viewed as not critical.

For the Priority Queue case, essential bandwidth load may be viewed as the critical parameter when dealing with lowest priority traffic class. However, in the case of highest priority class behaves exactly like in the FIFO case, i.e. the mean rate load is its critical parameter. In the Weighted Fair Queue (WFQ) case, essential bandwidth load and class mean rate load may be viewed as critical parameters.

The reliable regime for the method of the present invention method (as described above) is the so-called sub-critical regime. It may be characterized as follows:

### FIFO Queue

less than 80% of mean rate load;

### Priority Queue

Less than 80% of mean rate load (for the highest priority class) and Less than 80% of essential bandwidth load (for any lower priority classes). It should be noted that the essential bandwidth load is determined by taking into account traffic from the traffic class of interest as well as all traffic of higher priorities classes.

### Weighted Fair Queue

### For any traffic class (independent of weights) if total essential bandwidth load is less 80%, or

for a particular traffic class if class mean rate load is less 80%;

The unreliable regime for operation of the method of the present invention is the so-called super-critical regime, which may be characterized as follows:

### FIFO Queue

more than 90% of mean rate load;

### Priority Queue

### More than 90% of mean rate load (for the highest priority class), or

More than 90% of essential bandwidth load (for any lower priority classes). We note that here the essential bandwidth load is also determined by taking into account traffic from the traffic class of interest as well as all traffic of higher priorities classes.

### Weighted Fair Queue

### If both the critical parameters are more 80% then it is typically unsafe;

The boundary between safe and unsafe regimes is relatively small. In particular, in the FIFO case the congestion state is critical when mean rate load is about 80%-90%. It is also worth to mention that the invention method degrades gracefully under unsafe conditions (i.e. when the critical parameter is larger the safe threshold, i.e. 80%). The method of the present invention provides reliable estimation for a particular traffic aggregate of the essential bandwidth if the traffic aggregate is in the sub-critical congestion state during the measurement period.

The measurement is not so straightforward where there are several layers. However, the inventors have realised that the method may be taken as reliable if on the path of the aggregate (aggregate path) all nodes for all traffic classes involved in the aggregate of interest are in sub-critical congestion state. It will be appreciated that this condition is simpler and more efficient to check.

The method for doing performing such a check will now be described in greater detail. In particular, a characterization will be provided for when a particular traffic class at a particular node in 1-layer scenario is sub-critical or super-critical. Next, using this step a characterization for when the whole path is sub-critical or super-critical will be developed (a multi-layer scenario).

It will be appreciated, that it is important to take into account the aggregate path and traffic classes involved in the aggregate. Both of them are important for the determination of the traffic aggregate congestion state. The aggregate path includes all network nodes that the aggregate traffic passes through, i.e. between the point where the aggregate is defined and the point, where the probe is located.

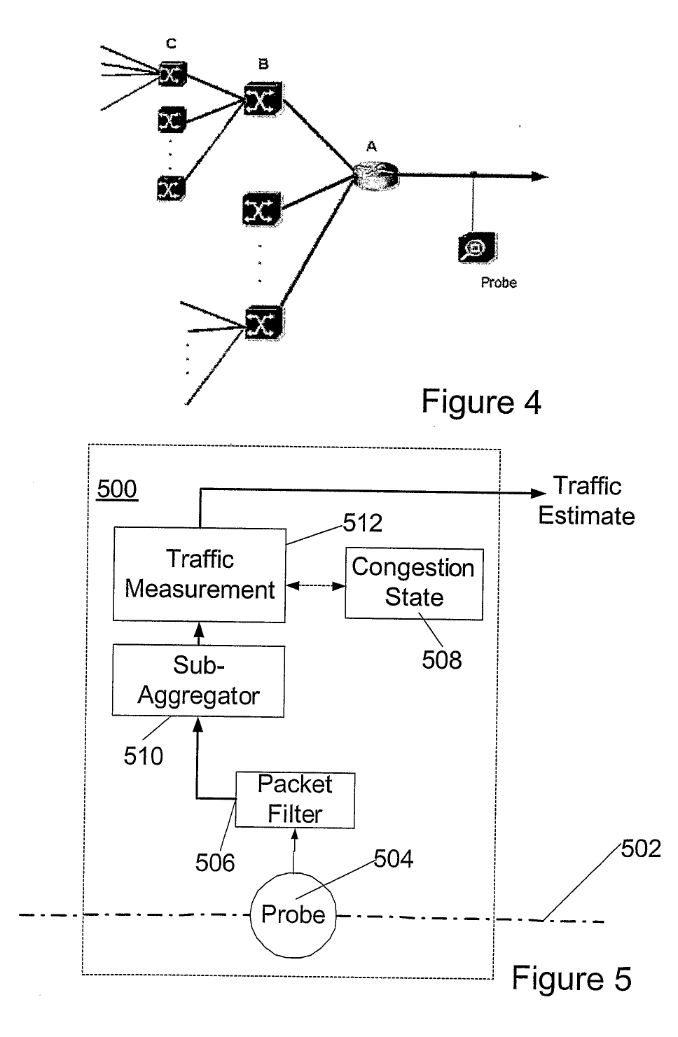

For example, for an aggregate defined at node C (see FIG. 4), the aggregate path is A-B-C. In order to have reliable estimations for the aggregate the corresponding ports at A, B and C must be sub-critical for all traffic classes involved in the aggregate.

First, it is noted that if all nodes in the path are “not congested” (i.e. in the sub-critical congestion state) then the invention method is reliable for the traffic aggregate. But if at least one node is “congested” (i.e. in the super-critical or critical congestion state) then the method of measurement of the present invention is likely to be unreliable for the traffic aggregate. For this reason, it can be said that the traffic aggregate congestion state is super-critical if at least one node is in not sub-critical congestion state.

Secondly, the traffic classes involved in the aggregate are applied according to the queuing scheduling hierarchy. It can be noted that if all traffic classes at a node involved in the aggregate are “not congested” then the invention method is reliable. Alternatively, if at least one traffic class at a node involved in the aggregate is “congested” then the estimations can be not reliable. For this reason, it may be said that the traffic aggregate congestion state is super-critical if at least one class involved in the aggregate is in not sub-critical congestion state.

Accordingly, in order to know when the estimations for an aggregate of interest using the invention method may be considered reliable knowledge of the following may be required:

aggregate path;
traffic classes involved in the aggregate;
congestion states for all traffic classes involved in the aggregate for each node on the aggregate path;

When this information is known, the problem is effectively reduced to the problem of the evaluation of the congestion state for only one node and one class, i.e. which traffic classes are not congested at a node.

To do this, the so-called primary aggregates are used that are simply total traffic associated with a particular traffic class at a particular node. We consider the method of the determination of the congestion state for a particular traffic class for different types of schedulers including the FIFO queue, Priority scheduler and WFQ scheduler. It will be appreciated that further rules may be developed for other schedulers.

The FIFO queue case is the simplest case to consider as in this case there is only one traffic class. Similarly, there is also only one primary aggregate P which represents the total traffic entering the FIFO queue.

As described above for the single level model, the algorithm for testing the congestion state of traffic in FIFO configured router may be simply stated as:

The FIFO queue is sub-critical if:

Mean_rate(P)/Link_Rate*100%<80%.

The FIFO queue is super-critical if:

Mean_rate(P)/Link_Rate*100%>90%.

### Otherwise the FIFO queue is critical.

The Priority queue case is more complicated than FIFO case. A simpler case having two priority classes will first be explained and then a more general case of priority queue with N traffic classes developed.

In the case of two traffic classes: higher priority and lower priority, there are also two primary aggregates associated with each class: higher priority primary aggregate (P_{H}), presenting the total traffic entering the higher priority queue and lower priority primary aggregate (P_{L}), presenting the total traffic entering the lower priority queue.

The Algorithm for the two priority class scheme may be stated as:

The higher priority traffic class is sub-critical if:

Mean_rate(P_{H})/Link_Rate*100%<80%.

### Otherwise the higher priority traffic class is super-critical.

The lower priority traffic class is sub-critical if:

EB_rate(P_{H}+P_{L})/Link_Rate*100%<80%.

### Otherwise the lower priority traffic class is super-critical.

It should be noted that if the lower priority class is sub-critical then the higher priority class is also sub-critical as the essential bandwidth is larger than the mean rate.

The general case of N priority traffic classes will now be considered. In the case of more than two priority classes the evaluation of the traffic class congestion state is similar. In this case we have N primary aggregates Pᵢ, i=1, . . . N, associated with each traffic class, respectively: highest priority primary aggregate (P₁) and lowest priority primary aggregate (P_{N}).

The algorithm may be stated as follows:
The highest priority traffic class is sub-critical if:

Mean_rate(P₁)/Link_Rate*100%<80%.

### Otherwise the highest priority traffic class is super-critical.

The priority traffic class i (1<i≦N) is sub-critical if:

EB_rate(P₁+ . . . +Pᵢ)/Link_Rate*100%<80%.

### Otherwise the priority traffic class i is super-critical.

In particular, the lowest priority traffic class N is sub-critical if:

EB_rate(P₁+ . . . +P_{N})/Link_Rate*100%<80%.

### Otherwise the lowest priority traffic class N is super-critical.

We note that if a lower priority class i is sub-critical then all higher priority classes j≦i are also sub-critical.

The WFQ scheduler case is a bit more complicated than the case of the Priority scheduler. Initially the simpler case with two classes will be described followed by the general case of N traffic classes.

In the case of two WFQ traffic classes: traffic class 1 and traffic class 2. We also have two primary aggregates associated with each class: primary aggregate of traffic class 1 (P₁) and primary aggregate of traffic class 2 (P₂). Let Wᵢ denote the traffic class weight for the traffic class i:

### W₁>0, i=1,2;

### W₁+W₂=1;

The algorithm may be stated as follows:
The traffic class i is sub-critical if:

Mean_rate(Pᵢ)/(Link_Rate*Wᵢ)*100%<80%.

or

EB_rate(P₁+P₂)/Link_Rate*100%<80%.

### Otherwise the traffic class i may be said to be super-critical.

In the case of more than two classes the evaluation of the traffic class congestion state is similar to the case of two traffic classes. However, in this case there are N primary aggregates Pᵢ, i=1, . . . , N, associated with each class. Let Wᵢ denote the traffic class weight for class i and

### Wᵢ>0; i=1, . . . , N;

### W₁+ . . . +W_{N}=1;

Accordingly, the algorithm may be stated as:
The traffic class i is sub-critical if:

Mean_rate(Pᵢ)/(Link_Rate*Wᵢ)*100%<80%.

or

EB_rate(P₁+P₂+ . . . +P_{N})/Link_Rate*100%<80%.

### Otherwise the traffic class i may be said to be super-critical.

After having developed the rules above, the overall algorithm for the evaluation of the traffic aggregate congestion state in multi-layer scenarios is relatively straightforward. The method begins with an evaluation of all nodes on the traffic aggregate path starting from the end (i.e. from the node attached to the probe) and along the path until the start. At each node we need to evaluate all traffic classes contributing to the traffic aggregate. If at some node at least one of traffic classes involved in the traffic aggregate is not sub-critical then the traffic aggregate congestion state is said to be super-critical and no further use of the algorithm is required. Otherwise the traffic aggregate congestion state is determined as sub-critical.

It will be appreciated by those skilled in the art that the selections of percentage figures are based on a level of estimation error and that different values of estimation error will result in different percentage levels for the sub-critical, critical and super-critical regions. Accordingly, the figures (for example of 80%) are merely given as exemplary and the actual figures selected in an implementation may vary slightly, e.g. by 2-5% either way (e.g. 75%-85% where stated nominally as 80%)

For the sake of completeness, certain definitions for loads will now be provided. In particular, the mean rate load may be taken as the ratio of the mean rate of total traffic to the link rate multiplied by 100%, the Essential bandwidth load may be taken as the ratio of the essential bandwidth (for a particular QoS target) of total traffic to the link rate multiplied by 100% and the class mean rate load may be taken as the ratio of the mean rate of the total class traffic to the link rate divided by class weight and multiplied 100%.

A second alternative method for the performing an estimate (e.g. a measurement of essential bandwidth) based on traffic aggregates before shaping will now be described. This method is also based on the splitting an aggregate into sub-aggregates. Moreover, the splitting of an aggregate into sub-aggregates is done in exactly the same way as in the previous method. The difference between this second method and the first described above is in how the measurement using the individual sub-aggregates of the series is performed to obtain a statistical measure for the traffic aggregate, i.e. how the sub-aggregates and their counters are used. In particular, the alternative method does not reconstruct the MSA CGFs at all. The method will now be described in detail.

As in the previous approach aggregate traffic is split into several sub-aggregates. The sub-aggregates are multiplexed together, with each sub-aggregate offset by some time constant. It is important that the time offsets of different sub-aggregates should be different. The choice and application of time constants may be performed in several different ways. For example, the sub-aggregates can be somehow ordered and the i-th sub-aggregate may be offset by i*Tₒ, where, for example, Tₒ=50 ms is offset time or some other value. We will call the total aggregate trace reconstructed in such a way as a reconstructed aggregate. The introduction of this time delays negates correlations between the various sub-aggregates and accordingly in the reconstructed aggregate. Thus the reconstructed traces, or measurements, may be supplied to a bandwidth requirement estimator or other tool as in the prior art, to determine for example the bandwidth required to satisfy QoS.

When it is appropriate, instead of multiplexing the traces, it is possible to measure the traces at Tₘ ms intervals, where, for example, Tₘ=5 ms, and then add the measurements of the i-th sub-aggregate with i*50 ms offsets.

The reconstructed traces or measurements may be used as an approximation of the traffic aggregate before shaping. These reconstructed traces, or measurements, may be supplied to a bandwidth requirement estimator (as known from the prior art) in order to determine the bandwidth required to satisfy QoS. For example, these reconstructed traces, or measurements, may be supplied to a Bandwidth Estimator. If the Bandwidth of the reconstructed traffic exceeds that of the observed shaped traffic, then it is a strong indication that the required bandwidth exceeds the shaping rate.

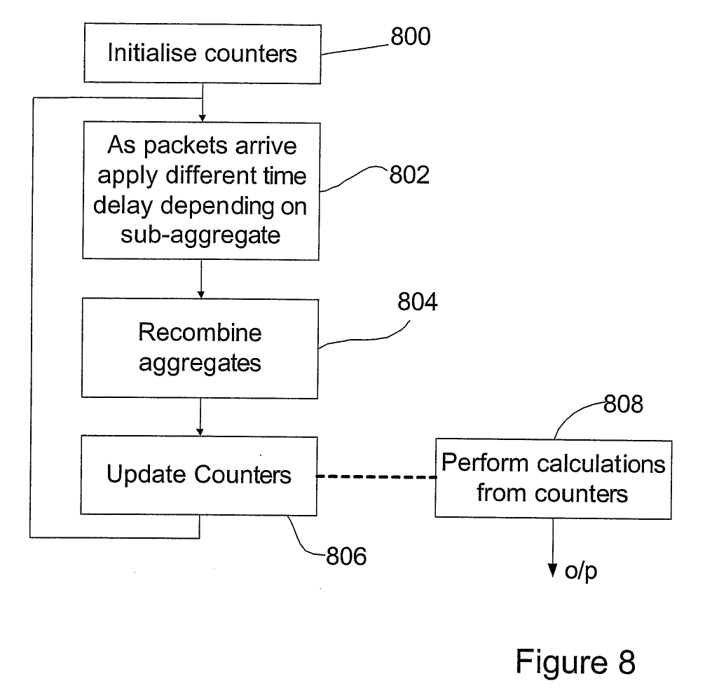

The Offset Method may be implemented in a number of different ways. However a particularly efficient algorithm will now be described, with reference to FIG. 8. This algorithm minimizes the memory requirements and is easily extended to reconstruct different numbers of sub-aggregates and different offsets.

If it is assumed that there are D sub-aggregates and measurements are supplied to a Bandwidth Estimator (as known from the prior art) every Tₘ ms, where Tₒ/Tₘ is some integer number. We will impose a Tₒ ms offset between (n+1)-th and n-th sub-aggregates, n=0, 1, . . . , D−1.

To implement this algorithm a “circular buffer” of M slots, M=(D−1)*Tₒ/Tₘ may be used to implement the delays for sub-aggregates. A current slot number p may then be used to keep reference to current slot in the circular buffer. A total reconstructed aggregate counter Cᵣ may then be used to supply measurements to a Bandwidth Estimator. An example of parameters is the following: M=100, D=11, T=5 ms, Tₒ=50 ms.

The implementation of the algorithm may be as follows:

### Initialise the counter Cᵣ to 0 (step 800).

### Initialise each slot counter (numbered 0 to M−1) to zero (step 800).

### Initialise the current slot number p to slot M/2.

### When a measurement arrives from the sub-aggregates 0, 1, . . . , D−1 (step 802):

### Retrieve the value in slot p of the buffer and increase Cᵣ by it;

Increase counter Cᵣ by the measurement retrieved from the 0-th sub-aggregate (step 802). The counter Cᵣ is used for bandwidth estimation (Step 808). The counter Cᵣ comprises two counters, the first measuring the volume of data, and the second measuring the quantity of data packets.

### Insert the measurement from the 1^{st} sub-aggregate into slot p, replacing any value already in slot p.

### For j=2,3, . . . , D−1, add the measurement from the j-th sub-aggregate to any existing measurement in slot [p−D*(j−1)] (modulo M)).

### Increment the current slot number p (step 806);

### If p>M, set p to zero (step 806).

In this way the values may be readily applied to a bandwidth estimator of the prior art.

It will be appreciated that an important advantage of the invention is that the method and probes are passive, i.e. they do not generate any additional traffic but only inspect packets, classify packets, update counters and make the essential bandwidth measurements. In particular, the present invention does not require any artificially generated traffic. Although the invention has been described with reference to the analysis of traffic at a simple probe it will be appreciated that this is exemplary of the application of the techniques of the present invention as it is not necessary to use an isolated probe. For example the methodology of the present invention can be used in a traffic analysing tool placed at any node or location in a data network within any device, including for example a router, and used to effectively monitor the traffic in another location.

It will further be appreciated that the subsequent analysis of the traffic can be used for a plurality of different purposes for example in weighted scheduler arrangements to determine the optimum weights to assign to each buffer, or as a parameter to describe traffic in a network. Such a traffic descriptor could for example include a relationship between the service rate and quality of service achieved at that service rate.

As will be appreciated by those skilled in the art a plurality of traffic analysers according to the invention can be implemented across a data network and used to create an analysis of traffic across the entire network. Similarly, rules can be applied such that different types of data for example Voice Data, Internet Traffic etc., can be analysed using the technique of the present invention and then treated differently depending on the output of the analysis.

It will be appreciated therefore that the techniques of the present invention may by modified in a number of differing fashions depending on the applications and level of accuracy required in the calculation.

It will be appreciated that the present invention and its use has been described with reference to graphical representations of these and as such where the present invention is described with reference to graphical representations, it will be appreciated that these graphical representations are purely for ease of understanding and are not intended to limit the present invention to these graphical representations. In particular, the present invention is not intended to be limited to the exemplary embodiments described herein, but instead is meant to include and extend to all equivalents which fall within the spirit and scope of the invention.

The words comprises/comprising when used in this specification are to specify the presence of stated features, integers, steps or components but does not preclude the presence or addition of one or more other features, integers, steps, components or groups thereof.

1. A method of analyzing a traffic aggregate of packets in a network comprising: separating the traffic aggregate into a series of individual co-temporal sub-aggregates; and performing a measurement using the individual sub-aggregates of the series to obtain a statistical measure for the traffic aggregate.

2. A method of analysing traffic according to claim 1, comprising identifying the traffic aggregate.

3. A method of analysing traffic according to claim 2, wherein a packet filter is used to identify the traffic aggregate.

4. A method of analysing traffic according to claim 1, wherein the method of separating the traffic aggregate is selected so as to provide statistical independence vis a vis the sub-aggregates.

5. A method of analysing traffic according to claim 1, wherein said separating uses a hash function to determine the appropriate sub-aggregate for a packet.

6. A method of analysing traffic according to claim 5 wherein the hash function has x possible results where x is the number of sub-aggregates.

7. A method of analysing traffic according to claim 5, wherein said hash function comprises a modulo division performed on the weighted sum of a plurality of fields from the packet header for of individual packets.

8. A method of analysing traffic according to claim 7, wherein the plurality of fields include at least one of the following: Source IP address, Source port number, destination IP address, destination port number and the TOS field.

9. A method of analysing traffic according to claim 5, wherein said hash function is defined as H(packet)=[a₁*source_IP_address+a₂* source_port_number+a₃*destination_IP_address+a₄*destination_port_number+a₅*TOS_field] (modulo M), where a₁, a₂, a₃, a₄ and a₅ are suitably selected constants and M is the number of sub aggregates.

10. A method of analysing traffic according to claim 1, wherein the performing a measurement comprises:
calculating individual cumulant generating functions, and
summing the calculated individual cumulant generating functions to provide a combined cumulant generating function which may function as a statistical measure for the traffic aggregate.

11. A method of analysing traffic according to claim 10, where the individual cumulant generating functions are calculated using many sources asymptotics.

12. A method of analysing traffic according to claim 1, wherein the performing a measurement using the individual sub-aggregates comprises time-shift multiplexing the sub-aggregates together to produce a reconstructed traffic aggregate, and performing a calculation on the reconstructed traffic aggregate to produce a traffic estimate.

13. A method of analysing traffic according to claim 12, wherein each sub-aggregate is time-shifted by a separate amount.

14. A method of analysing traffic according to claim 1 comprising estimating a traffic congestion state on the network to provide an indicator for the reliability of the traffic estimate.

15. A method according to claim 14, wherein said traffic congestion state is calculated by determining a load level for the traffic.

16. A method according to claim 15, wherein the there are a number of intervening points between the location of the point of measurement for the traffic aggregate and the actual traffic aggregate itself and wherein the traffic congestion state is determined at each of said intervening points.

17. A system for analysing traffic in a network comprising:
a traffic aggregator for identifying a traffic aggregate of interest,
a sub-aggregator for separating the traffic aggregate into a series of individual sub-aggregates, where each sub-aggregate and the aggregate are co-temporal, and
a traffic measurement module for performing a measurement using the individual sub-aggregates of the series to obtain a statistical measure for the traffic aggregate.

18. A system for analysing traffic in a network according to claim 17, wherein the traffic aggregator comprises a packet filter.

19. A system for analysing traffic in a network according to claim 17, wherein the sub-aggregator is adapted to separate the traffic aggregate with substantially statistical independence between sub-aggregates.

20. A system for analysing traffic in a network according to claim 19, wherein the sub-aggregator is adapted to separate the traffic aggregate using a hash function for each packet in the aggregate.

21. A system for analysing traffic in a network according to claim 20, wherein the hash function has x possible results where x is the number of sub-aggregates.

22. A system for analysing traffic in a network according to claim 20, wherein the hash function comprises a modulo division performed on the weighted sum of a plurality of fields from the packet headers of individual packets.

23. A system for analysing traffic in a network according to claim 22, wherein the plurality of fields include at least one of the following:
source IP address, source port number, destination IP address, destination port number and the TOS field.

24. A system for analysing traffic in a network according to claim 23, wherein said hash function is defined as H(packet)=[a₁*source_IP_address+a₂* source_port_number+a₃*destination_IP_address+a₄*destination_port_number+a₅*TOS_field] (modulo M), where a₁, a₂, a₃, a₄ and a₅ are suitably selected constants and M is the number of sub aggregates.

25. A system for analysing traffic in a network according to claim 17, wherein the traffic measurement module is adapted to:
calculate individual cumulant generating functions, and sum the calculated individual cumulant generating functions to provide a combined cumulant generating function which may function as a statistical measure for the traffic aggregate.

26. A system for analysing traffic in a network according to claim 25, wherein the traffic measurement module is adapted to calculate the individual cumulant generating functions using many sources asymptotics.

27. A system for analysing traffic in a network according to claim 17, wherein the traffic measurement module is adapted to time-shift multiplex the sub-aggregates together to produce a reconstructed traffic aggregate, and is further adapted to calculate a traffic estimate from the reconstructed traffic aggregate.

28. A system for analysing traffic in a network according to claim 27, wherein the traffic measurement module is adapted to apply a different time shift to each sub-aggregate.

29. A system for analysing traffic in a network according to claim 17, further comprising a congestion state module for providing an indicator of the traffic congestion on the network.

30. A system for analysing traffic in a network according to claim 29, wherein the traffic congestion module is adapted to determine said indicator by determining a load level for the traffic.

31. A system for analysing traffic in a network according to claim 29 in situations where there are a number of intervening points between the location of the point of measurement for the traffic aggregate and the actual traffic aggregate itself and wherein the traffic congestion module is adapted to determine said indicator by determining the traffic congestion state at each of said intervening points.
